(19) United States
(12) Patent Application Publication
(10) Pub. No.: US 2017/0277239 A1
(43) Pub. Date: Sep. 28, 2017

(54) Power Control System

(71) Applicant: Darrion Devine White, Memphis, TN (US)

(72) Inventor: Darrion Devine White, Memphis, TN (US)

(21) Appl. No.: 15/467,641

(22) Filed: Mar. 23, 2017

Related U.S. Application Data
(60) Provisional application No. 62/312,507, filed on Mar. 24, 2016.

(51) Int. Cl. G06F 1/26; G06K 9/00; G06F 21/32

(52) U.S. Cl. CPC G06F 1/266; G06F 21/32; G06K 9/00013; G06K 9/00087

(57) ABSTRACT

A power control system. The power control system includes a housing having a transceiver adapted to communicate with an electronic device, such as an appliance or computer. The electronic device can be selected by a selection button on the housing and have the power system controlled by a control switch, also on the housing. The power control system includes logic that, when executed at least in part by a processor, establishes a communication relationship between the power control system and the one or more electronic devices. The logic also receives a selection input from the one or more selection buttons. Further, the power control system transmits a command to the power system of at the selected electronic devices upon actuation of the control switch. In one version, the power control system includes a biometric sensor that captures biometric data to allow only authorized users from controlling the selected electronic devices

### CROSS REFERENCE TO RELATED APPLICATION

This application claims the benefit of U.S. Provisional Application No. 62/312,507 filed on Mar. 24, 2016. The above identified patent application is herein incorporated by reference in its entirety to provide continuity of disclosure.

### BACKGROUND OF THE INVENTION

### Field of the Invention

The present invention relates to a power control system. More specifically, the present invention provides a power control system that remotely activates or deactivates power supply to electronic devices.

Electrical energy is the most common power source for appliances, tools, computers, and the like. Generally, these electronic devices have a wired connection to a wall outlet and electrical network. For most electronic devices, the power switch that controls the supply of electrical energy to the electronic device is located in close proximity to the electronic device, forcing a user to manually activate and deactivate the electronic device. There exists a need for a power control system that remotely controls power supply to electronic devices.

Devices have been disclosed in the known art that relate to power control. These include devices that have been patented and published in patent application publications. These devices in the known art have several known drawbacks. For example,

In light of the devices disclosed in the known art, it is submitted that the present invention substantially diverges in design elements from the devices in the known art and consequently it is clear that there is a need in the art for an improvement to existing power control systems devices. In this regard the instant invention substantially fulfills these needs.

### SUMMARY OF THE INVENTION

In view of the foregoing disadvantages inherent in the known types of power control system now present in the art, the present invention provides a new power control system wherein the same can be utilized for providing convenience for the user when located remote from the electronic device.

It is therefore an object of the present invention to provide a new and improved power control system that allows multiple electronic devices to be controlled remotely from a single apparatus.

It is another object of the present invention to provide a power control system that utilizes the circuitry and power supply of the electronic device to control power supply.

Another object of the present invention is to provide a power control system that utilizes a biometric sensor to allow only authorized users to control the selected electronic device.

Another object of the present invention is to provide a power control system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of the power control system.

FIG. 2 shows a flowchart of one method performed by the power control system.

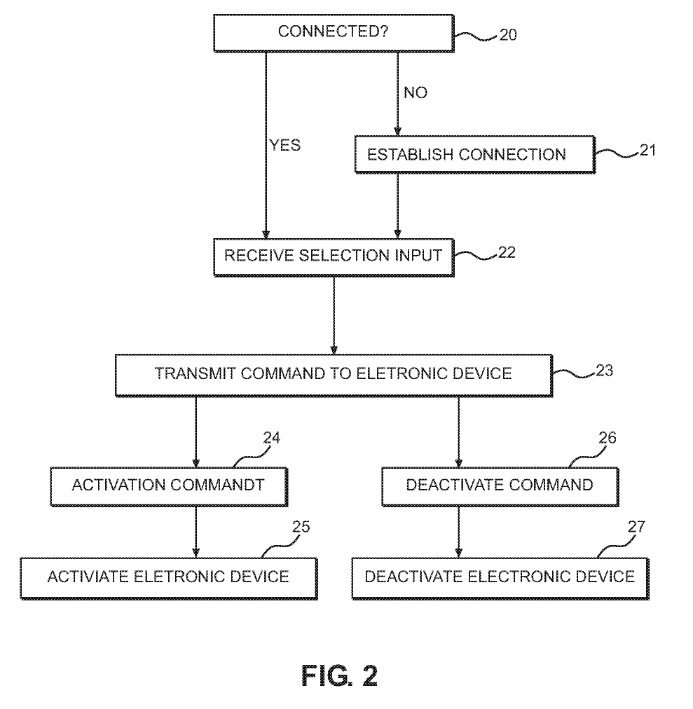

FIG. 3 a flowchart of another method performed by the power control system.

### DETAILED DESCRIPTION OF THE INVENTION

Reference is made herein to the attached drawings. Like reference numerals are used throughout the drawings to depict like or similar elements of the power control system. For the purposes of presenting a brief and clear description of the present invention, the preferred embodiment will be discussed as used for activating, deactivating, or otherwise controlling the power supply of paired electronic devices. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals.

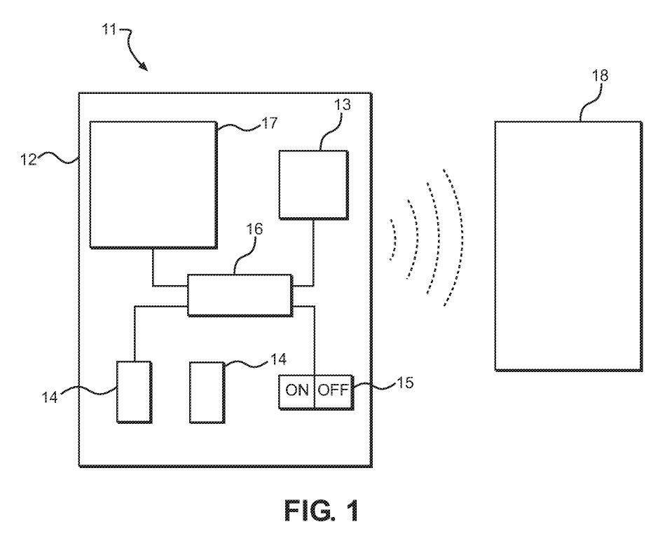

Referring to FIG. 1, there is shown a block diagram of the power control system. The power control system 11 comprises a housing 12 having a transceiver 13 configured to communicate with an electronic device 18, such as an appliance, computer, and the like. The transceiver 13 is adapted for wired and wireless communication, utilizing communication networks such as the internet, and communication protocols, such as Bluetooth and Wi-Fi. The housing 12 further includes one or more selection buttons 14, wherein each selection button 14 is configured to correspond to at least one of the electronic devices 18. In this way, the power control system 11 may be in communication with multiple electronic devices 18 simultaneously.

The transceiver 13 is operably connected to a control switch 15. The control switch 15 is configured to control a power system of the one or more electronic devices 18. In the shown embodiment, the control switch 15 is a toggle switch or rocker switch, that activates or deactivates the electronic device or devices 18 selected by the selection buttons 14. In the shown embodiment, the control switch 15 is operably connected to a biometric sensor 17 that is configured to capture biometric data, such as fingerprint images, retinal images, and the like. In one embodiment, the biometric sensor 17 is a fingerprint scanner configured to capture a fingerprint image. The biometric sensor 17 provides security to the power control system 11, as only authorized users may control the electronic device 18.

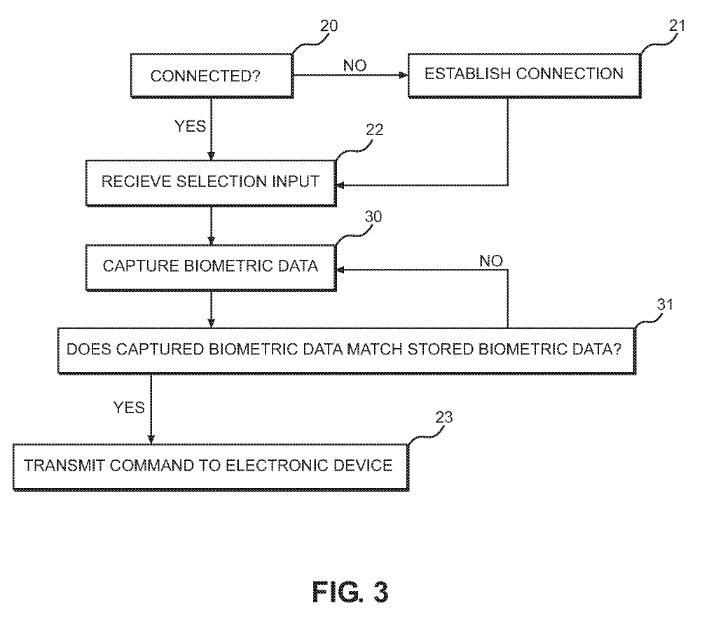

Referring to FIG. 3, there is shown a flowchart of one method performed by the power control system. The power control system includes logic, wherein the logic is at least partially stored in a non-transitory computer readable medium and that, when executed at least in part by a processor, causes the power control system to perform a method. The method includes detecting 20 and establishing a communication relationship 21 between the power control system and the one or more electronic devices. Once established, a selection input is received 22 from the one or more selection buttons, wherein the selection input selects at least one of the one or more electronic devices. A command is transmitted 23 from the transceiver to at least one of the selected electronic devices upon actuation of the control switch. In one embodiment, the command is either an activation command 24 that causes the electronic device to activate 25, or a deactivation command 26 that causes the electronic device to deactivate 27. However, in alternative embodiments, the commands may be programmable, such that a variable amount of power may be utilized by the electronic device.

Referring to FIG. 3, there is shown a flowchart of another method performed by the power control system. In this method, the power control system includes the biometric sensor captures biometric data 30, and matches the captured biometric data to stored biometric data 31. The stored biometric data may be preprogrammed on non-transitory computer readable medium of the power control system or located on a remote server. If the captured biometric data matches the stored biometric data, then the command is permitted to be transmitted 23 from the transceiver to at least one of the selected electronic devices.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A power control system, comprising:
a housing including a transceiver, the transceiver configured to communicate with one or more electronic devices;
one or more selection buttons disposed on the housing, each of the one or more selection buttons configured to correspond to at least one of the electronic devices;
the transceiver operably connected to a control switch, the control switch configured to control a power system of the one or more electronic devices;
a logic that is at least partially stored in a non-transitory computer readable medium and that, when executed at least in part by a processor, causes the power control system to perform a method, the method comprising:
establishing communication relationship between the power control system and the one or more electronic devices;
receiving a selection input from the one or more selection buttons, wherein the selection input selects at least one of the one or more electronic devices;
transmitting a command to the power system of at least one of the selected electronic devices upon actuation of the control switch.

2) The power control system of claim 1, wherein a command is a deactivation command.

3) The power control system of claim 1, wherein a command is an activation command.

4) The power control system of claim 1, wherein

5) The power control system of claim 1, wherein the control switch is operably connected to a biometric sensor, the biometric sensor configured to capture biometric data.

6) The power control system of claim 5, wherein the biometric sensor is a fingerprint scanner, the fingerprint scanner configured to capture a fingerprint image.

7) The power control system of claim 5, wherein the method further comprises:
capturing biometric data via the biometric sensor;
matching the biometric data to a set of stored biometric data;
whereupon matching the captured biometric data to at least one of the sets of stored biometric data, permitting the transmitting of the command to the power system of at least one of the selected electronic devices upon actuation of the control switch.
